(19) United States
(12) Patent Application Publication
(10) Pub. No.: US 2006/0212443 A1
(43) Pub. Date: Sep. 21, 2006

(54) Contextual interactive support system

(76) Inventor: Guillermo A. Oyarce, Denton, TX (US)

Correspondence Address: WILLIAMS, MORGAN & AMERSON, 10333 RICHMOND, SUITE 1100, HOUSTON, TX, 77042, US

(21) Appl. No.: 11/373,886

(22) Filed: Mar. 13, 2006

Related U.S. Application Data
(60) Provisional application No. 60/663,095, filed on Mar. 18, 2005.

(51) Int. Cl. G06F 17/30

(52) U.S. Cl. 707/5

(57) ABSTRACT

The present invention provides a method and a graphical user interface for contextual interactive support. The method includes providing information indicative of a plurality of words selected from a document set, receiving information indicative of a selected subset of the plurality of words, and determining context representations associated with each of the words in the selected subset. The method also includes providing information indicative of the context representations, receiving information indicative of at least one first phrase formed based on the words in the selected subset and the associated context representations, and searching the document set using the information indicative of the first phrase.

### BACKGROUND OF THE INVENTION

1. Field of the Invention

This invention relates generally to processor-based systems, and, more particularly, to a contextual interactive support system.

2. Description of the Related Art

The large and growing pervasiveness of electronic documents is enriching the information environment available to users. However, the abundance of information often leads to cognitive overload as users attempt to locate relevant information within an almost infinite and constantly expanding universe of potentially related documents. Computer-based text processing may therefore be used to analyze large and complex sets of documents and to filter out extraneous information. For example, computer-based text processing may be used to retrieve relevant documents from a large document set based upon a query provided by a user. Exemplary computer-based text processing tasks include information retrieval, analysis, evaluation, synthesis, summarization, and the like.

Typical documents include words, phrases, and numerous other symbols. Word frequencies may be used to identify relevant documents in a document set. For example, words that are closely associated with an upper concept of a document set (e.g., the general topic that includes contextual matter common to the document set) are typically expected to be associated with, and relevant to, the upper concept. Words that appear with a lower frequency are conversely expected to be less closely associated with, and less relevant to, the upper concept of the document set. Thus, documents that include selected words at a relatively high frequency are likely to include information associated with an upper concept that is closely related to the selected words. For example, documents that include the word “cat” at a relatively high frequency likely include information related to “cats” and these documents may be selected in response to a query from a user requesting information about “cats.”

Users may not be able to compose effective queries to locate relevant documents by simply combining high-frequency words. In particular, the words and concepts in the documents may not be useful unless their context is made obvious. For example, a query provided by the user may indicate that certain words, such as “cat,” are relevant and so documents that include the word “cat” may be relevant to the user. However, the word “cat” may appear with relatively high frequency in an enormous number of documents, not all of which may be of interest to a user looking for information regarding “house cats.” Furthermore, not all the words in each document, or the word combinations that form the phrases in the documents, may be relevant, even though they may appear in documents that may be considered relevant by the user. For example, the words “house” and “cat” may appear with a high frequency in documents that are not relevant to the subject of “house cats,” and some instances of the words “house” and/or “cat” may not be relevant, even if they appear in a document that is relevant to the subject of “house cats.” Thus, context identification may be a prerequisite for many text processing tasks.

Conventional text processing tools do not typically provide a mechanism for defining and/or refining context information associated with the words used to locate relevant documents. For example, interfaces to conventional information retrieval systems, of which search engines are a particular instance, typically do not permit users to define and/or refine context information associated with particular words. Accordingly, the likelihood that conventional information retrieval systems will locate and retrieve documents that include the most relevant information may be significantly reduced. Moreover, the amount of information that must be processed by the user (e.g., the number of retrieved documents that must be reviewed to determine their relevance) may be quite large, which may increase the likelihood of cognitive overload.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for contextual interactive support. The method includes providing information indicative of a plurality of words selected from a document set, receiving information indicative of a selected subset of the plurality of words, and determining context representations associated with each of the words in the selected subset. The method also includes providing information indicative of the context representations, receiving information indicative of at least one first phrase formed based on the words in the selected subset and the associated context representations, and searching the document set using the information indicative of the first phrase.

In another embodiment of the present invention, a graphical user interface is provided for contextual interactive support. The graphical user interface enables a user to access a plurality of words selected from a document set, select at least one of the plurality of words, and access context representations associated with each of the selected words. The graphical user interface also enables the user to form at least one phrase based upon the selected words and the associated context representations, and to initiate a search of the document set based upon the at least one phrase.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a computer system that may be used to provide contextual interactive support, in accordance with the present invention;

FIG. 2 shows one exemplary embodiment of a graphical user interface for a contextual interactive support system, in accordance with the present invention; and

FIG. 3 conceptually illustrates one exemplary embodiment of a method for contextual interactive support, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

A contextual interactive support system, sometimes referred to by the acronym KISS (Kontextual Interactive Support System), may provide techniques for analyzing and evaluating document sets. Persons of ordinary skill in the art should appreciate that the document set may include a plurality of distinct documents, a plurality of portions of a document, or any combination thereof. The contextual interactive support system may also be used to provide a context for words, combinations of words, and/or concepts present in the document sets. The term “phrase” will be used hereinafter to refer to combinations of words.

In one embodiment, a contextual interactive support system interface, such as a graphical user interface, supplies one or more users with access to significant information elements in the body of documents from the document set. These informational elements, which may include words, phrases, concepts, or any combination thereof, may be better interpreted when placed in an appropriate context. Accordingly, the contextual interactive support system interface may also supply a user with a representation of the different context within which one or more selected words, phrases, and/or concepts exist. In one embodiment, the context may be provided in conjunction with a contextual phrase analyzer engine. An exemplary contextual phrase analyzer engine is described in U.S. patent application Ser. No. ______ entitled, “A Contextual Phrase Analyzer,” which is submitted concurrently herewith and is incorporated herein by reference in its entirety.

In one exemplary embodiment, the contextual phrase analyzer engine may be used to analyze the document set. A lookup table of linguistic terms may be constructed based upon the document set. Frequencies and/or frequency distributions associated with the linguistic terms may also be determined based upon the document set. For example, the lookup table may include words extracted from the document set, as well as the frequencies of the words and one or more documents associated with each of the words. One or more relatively important words may be determined based upon the words, frequencies, and/or associated documents extracted from the document set. For example, words in the lookup table may be ranked based, at least in part, on the frequencies and/or frequency distributions associated with these words.

The lookup table may also include linguistic terms that are combinations of the extracted words, i.e. phrases. For example, phrases including pairs of adjacent words, or other groups of associated words, may be formed using the extracted word list. Frequencies of the phrases and one or more documents associated with each of the linguistic terms may also be determined and included in the lookup table. One or more relatively important phrases may be determined based upon the words and/or phrases extracted from the document set. For example, phrases in the lookup table may be ranked based, at least in part, on the frequencies and/or frequency distributions associated with these phrases.

The linguistic terms, particularly the higher ranked and/or the relatively more important linguistic terms, may be provided to the user by a contextual interactive support system interface. The user may use the identified important words and/or phrases to identify important documents and/or portions of documents in the document set. The system and/or user may also use these terms to form and/or refine searches of the document set or some other document set. As the user interacts with the contextual interactive support system interface, better phrases may be constructed so that the user may actively discover additional relevant information. This process may also help to filter out extraneous information as the system may only build phrases by allowing the user to put together relevant text-context combinations.

The contextual interactive support system interface may provide a number of advantages at the cognitive level of the user. For example, by allowing the user to discover and construct relevant phrases and providing immediate access to those specific phrases within their context, users may avoid having to inspect large quantities of extraneous information. The contextual interactive support system interface may also help the user avoid viewing documents as the ultimate container of information, but instead may treat the documents as the combination of even smaller containers. Thus, the contextual interactive support system may reduce the time of task and provide easier manipulation of the information.

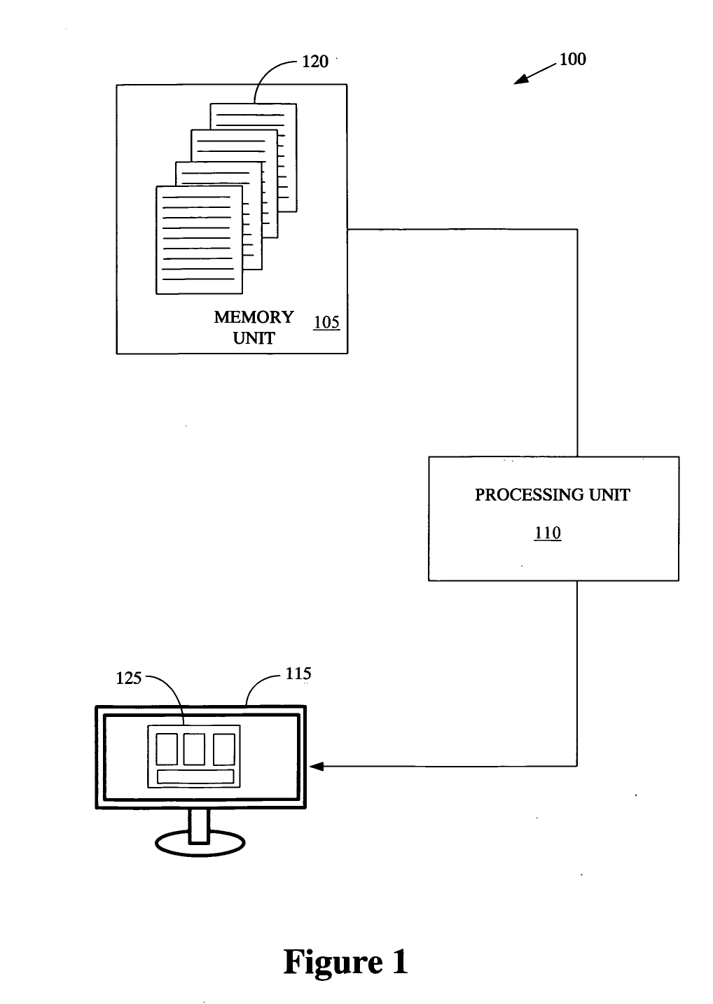

FIG. 1 conceptually illustrates one exemplary embodiment of a computer system 100 that may be used to implement a contextual interactive support system. In the illustrated embodiment, the computer system 100 includes a memory unit 105, a processing unit 110, and a display device 115. However, persons of ordinary skill in the art having benefit of the present disclosure should appreciate that the computer system 100 may include more or fewer components. For example, the computer system 100 may include additional memory units 105, processing units 110, and/or display devices 115, as well as other components not shown in FIG. 1. For another example, the computer system 100 may not include a display device 115. Furthermore, persons of ordinary skill in the art having benefit of the present disclosure should appreciate that the computer system 100, the memory unit 105, the processing unit 110, and/or the display device 115 may be implemented using hardware, firmware, software, or any combination thereof.

In the illustrated embodiment, the memory units 105 stores information indicative of one or more documents 120. As used herein and in accordance with common usage in the art, the term “document” is defined as the instantiation of a given upper concept of such specificity that no one single word can encompass the upper concept perfectly. Documents typically include words, numbers, and other symbols. In one embodiment, the documents 120 may be implemented as one or more files that may be stored in the memory unit 105. The documents 120 may also form a document set that includes one or more of the documents 120. As used herein and in accordance with common usage in the art, the term “document set” may be defined as the instantiation or representation of a given super upper concept that includes a combination of several individual documents that represent one or more subordinate upper concepts.

The processing unit 110 is configured to provide information indicative of words selected from the documents 120. In the illustrated embodiment, the information indicative of the words selected from the documents 120 are presented using a graphical user interface 125 that may be displayed using the display device 115. However, persons of ordinary skill in the art having benefit of the present disclosure should appreciate that the selected words may be provided or displayed in any manner and using any device or combination of devices.

In one embodiment, the displayed words may be selected from the documents 120 by the processing unit 110 based on a document frequency associated with the words and/or a word frequency associated with the words. As used herein and in accordance with common usage in the art, the term “document frequency” will be understood to indicate the number of documents within a document set that include a selected word. The document frequency may be expressed as a number of documents, a percentage of documents, or in any other form. As used herein and in accordance with common usage in the art, the term “word frequency” will be understood to indicate the number of instances of a word within the documents 120. The word frequency may be expressed as a number of words, an average number of words per document 120, or in any other form. Techniques for selecting the words are presented in the aforementioned U.S. patent application Ser. No. ______, entitled, “A Contextual Phrase Analyzer,” which is submitted concurrently herewith and is incorporated herein by reference in its entirety.

One or more of the words selected from the documents 120 may then be selected and provided to the processing unit 110. In one embodiment, a user may select a subset of the words that have been selected from the documents 120 using the graphical user interface 125. The selected subset of words (or information indicative thereof) may then be provided to the processing unit 110.

The processing unit 110 may determine one or more context representations associated with each of the words in the selected subset. As used herein and in accordance with common usage in the art, the term “context representation” will be understood to refer to any information indicative of, or associated with, the context of an associated word or phrase. In one embodiment, the context representation may include words adjacent to the word or phrase. For example, the context representation of the word “cat” may include the words “jungle” and/or “house” if the phrases “jungle cat” and/or “house cat” are used. However, the present invention is not limited to context representations that include adjacent words or phrases. In alternative embodiments, context representations may include other information associated with a particular word or phrase, such as information in a title, abstract, or summary of a document including the word or phrase, as well as other letters, numbers, and/or symbols associated with a word or phrase.

The context representations associated with words in the selected subset may be determined using information included in or associated with the documents 120. In one embodiment, the processing unit 110 may search the documents 120 for instances of the words in the selected subsets. For example, the processing unit 110 may search the documents 120 for instances of the word “cat.” If instances of the words are found in one or more of the documents 120, portions of the documents 120 may be used to define the context representations associated with the words. For example, if one or more instances of the word “cat” are adjacent the word “house,” then the context representation of the word “cat” may include the word “house.” However, as discussed above, the context representations may include any information retrieved from or associated with the documents 120.

The words in the selected subset and the associated context representations may then be provided. In one embodiment, the words in the selected subset and the associated context representations are provided to a user via the graphical user interface 125. The user may then use the graphical user interface 125 to select one or more of the words in the selected subset based on the associated context representations. The selected words (or other words that may be suggested by the context representation) may then be used to form one or more phrases, i.e., one or more combinations of words. For example, the selected subset may include instances of the word “cat” that are associated with the context representation “house” in other instances of the word “cat” that are associated with the context representation “jungle.” If the user is interested in forming a query to locate information associated with “house cats” the user may combine the word “cat” and the word “house”.

The selected phrase may then be provided to the processing unit 110, which may use the selected phrase to search one or more of the documents 120. In one embodiment, the processing unit 110 may search for instances of the selected phrase in the documents 120 and may return information proximate to (or relevant to) instances of the selected phrase that are found in the documents 120. For example, the processing unit 110 may return sentences and/or paragraphs that include the selected phrase. This information (which may be considered a context representation associated with the selected phrase) may then be provided to the user, e.g. via the graphical user interface 125. In one embodiment, the user may further refine the query based on the returned information/context representation. This process may be repeated by the user substantially indefinitely until a query of sufficient specificity to return the relevant documents 120 sought by the user has been constructed.

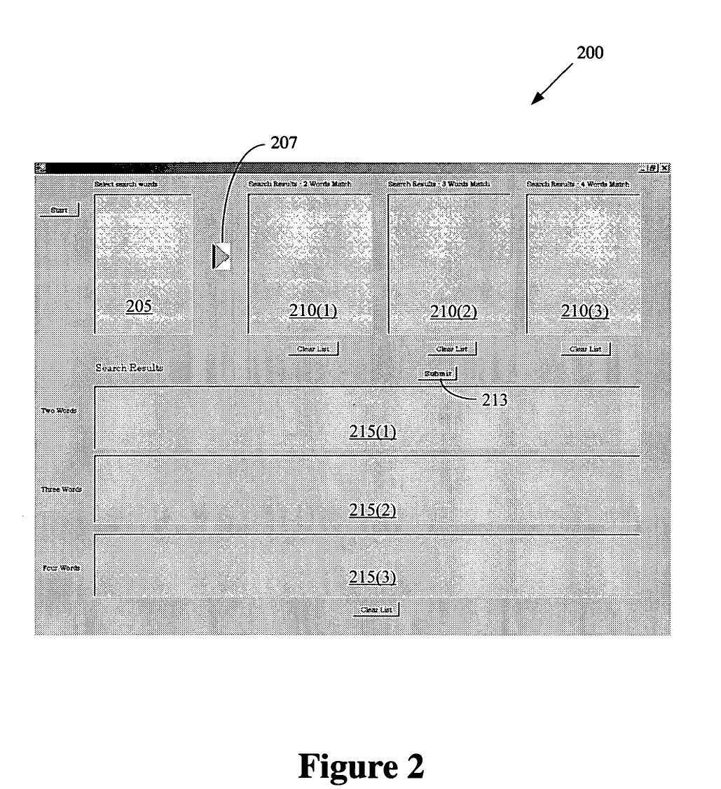

FIG. 2 shows one exemplary embodiment of a contextual interactive support system interface 200. In the illustrated embodiment, the words selected from one or more documents are provided in a list 205 and a user may select search words from the list 205. For example, the user may select one or more search words from a list of words extracted from document sets analyzed by a contextual phrase analyzer engine. In one embodiment, the words and/or phrases may be listed in order of their importance and/or ranking, as determined by the contextual phrase analyzer engine. The user may construct phrases consisting of two or more of the selected words in the list 205 and may initiate a search for context representations associated with these words, e.g., by “clicking” on the graphical user interface button 207. Context representations (i.e., search results) associated with the phrases may then be displayed using the graphical user interface 200. For example, search results in which two, three, and four words match may be presented as lists in windows 210(1-3), respectively, of the contextual interactive support system interface 200.

The lists in windows 210(1-3) may be used to construct additional phrases based on the search results and additional searches may be performed by submitting the phrases, e.g., by “clicking” on the graphical user interface button 213. The results of the searches may be displayed by the graphical user interface 200. For example, the results of searches having two words, three words, or four words may be displayed in the windows 215(1-3), respectively, of the graphical user interface 200. However, persons of ordinary skill in the art having benefit of the present disclosure should appreciate that the graphical user interface 200 is not limited to these particular numbers of words or phrases. In alternative embodiments, the graphical user interface 200 may support searches of any number of words and/or phrases. Furthermore, persons of ordinary skill in the art having benefit of the present disclosure should also appreciate that the graphical user interface 200 is not limited to the two levels of query refinement depicted in FIG. 2. As discussed above, the process of refining queries by modifying the search phrases may continue substantially indefinitely.

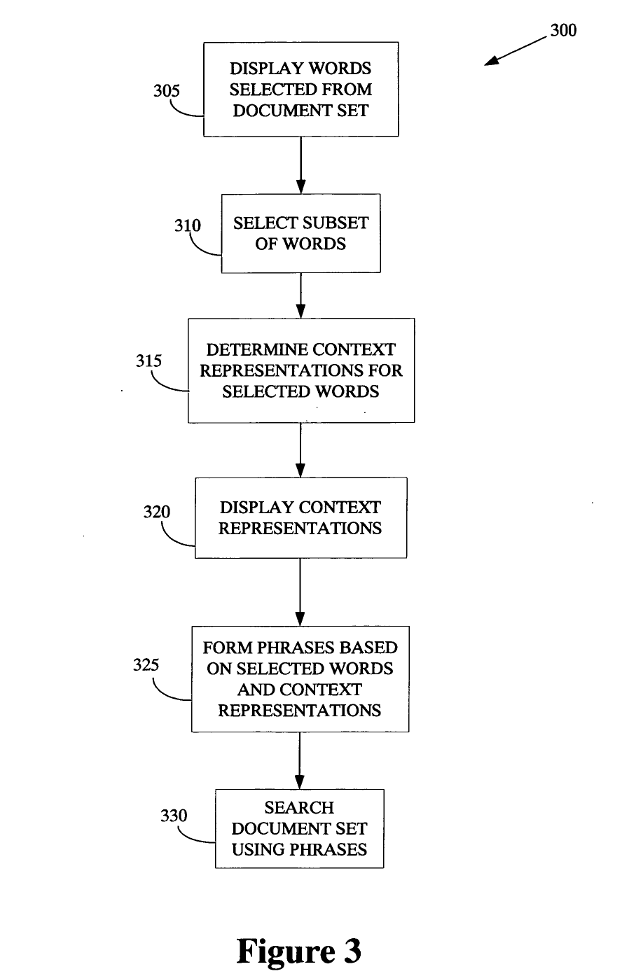

FIG. 3 conceptually illustrates one exemplary embodiment of a method 300 for contextual interactive support. In the illustrated embodiment, one or more words selected from a document sets may be displayed (at 305) using, for example, a graphical user interface. A user may then select (at 305) a subset of the displayed words and information indicative of the selected subset may be provided and used to determine (at 315) context representations associated with each of the selected words, as discussed in detail above. The context representations associated with each of the selected words may then be displayed (at 320) using the graphical user interface. The user may then form (at 325) one or more phrases, which may be used as queries for searching (at 330) documents in the document set, as discussed above.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
receiving information indicative of a selected subset of a plurality of words selected from a document set;
determining context representations associated with each of the words in the selected subset;
providing information indicative of the context representations;
receiving information indicative of at least one first phrase formed based on the words in the selected subset and the associated context representations; and
searching the document set using the information indicative of said at least one first phrase.

2. The method of claim 1, comprising providing information indicative of the plurality of words selected from the document set, and wherein the plurality of words is selected based on at least one document frequency associated with the plurality of words.

3. The method of claim 2, wherein providing the information indicative of the plurality of words selected from the document set comprises providing information indicative of a plurality of words selected based on word frequencies associated with each of the plurality of words.

4. The method of claim 1, wherein receiving information indicative of the selected subset comprises receiving the information indicative of the subset selected by a user using a graphical user interface.

5. The method of claim 4, wherein receiving the information indicative of the selected subset comprises receiving the information indicative of the subset selected by the user in response to providing the information indicative of the selected subset via the graphical user interface.

6. The method of claim 1, wherein determining context representations associated with each of the words in the selected subset comprises identifying at least one word that appears adjacent each of the words in the selected subset in the document set.

7. The method of claim 1, wherein receiving the information indicative of said at least one first phrase comprises receiving the information indicative of at least one first phrase selected by a user using a graphical user interface.

8. The method of claim 7, wherein receiving the information indicative of said at least one first phrase comprises receiving the information indicative of said at least one first phrase selected by the user in response to providing the information indicative of the context representations via the graphical user interface.

9. The method of claim 1, wherein searching the document set using said at least one first phrase comprises identifying a portion of the document set associated with said at least one first phrase.

10. The method of claim 9, further comprising providing information indicative of the identified portion of the document set.

11. The method of claim 10, wherein providing the information indicative of the identified portion of the document set comprises providing the information indicative of the identified portion of the document set via a graphical user interface.

12. The method of claim 10, further comprising receiving information indicative of at least one second phrase formed based upon said at least one first phrase and the information indicative of the identified portion of the document set.

13. The method of claim 12, further comprising searching the document set based on said at least one second phrase.

14. A graphical user interface that enables a user to:
access a plurality of words selected from a document set;
select at least one of the plurality of words;
access context representations associated with each of the selected words;
form at least one phrase based upon the selected words and the associated context representations; and
initiate a search of the document set based upon the at least one phrase.

15. The graphical user interface of claim 14, wherein the user is enabled to access a plurality of words selected based on at least one document frequency associated with the plurality of words.

16. The graphical user interface of claim 15, wherein the user is enabled to access a plurality of words selected based on word frequencies associated with each of the plurality of words.

17. The graphical user interface of claim 14, wherein the user is enabled to access at least one word that appears adjacent each of the words in the selected subset in the document set.

18. The graphical user interface of claim 14, wherein the user is enabled to access a portion of the document set associated with said at least one first phrase.

19. The graphical user interface of claim 18, wherein the user is enabled to form at least one second phrase based upon said at least one first phrase and the information indicative of the identified portion of the document set.

20. The graphical user interface of claim 19, wherein the user is enabled to initiate a search of the document set based on said at least one second phrase.
